(19) United States
(12) Patent Application Publication
(10) Pub. No.: US 2008/0115161 A1
(43) Pub. Date: May 15, 2008

(54) DELIVERING USER-SELECTED VIDEO ADVERTISEMENTS

(75) Inventor: Yair Kurzion, Los Altos, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 11/554,333

(22) Filed: Oct. 30, 2006

(51) Int. Cl. H04N 7/16; H04N 7/025; H04N 7/10

(52) U.S. Cl. 725/32; 725/135; 725/34; 725/62

(57) ABSTRACT

A user request to view a video is received, and at least two advertisement options are provided to the user. The user selects one of the at least two advertisement options. An advertisement associated with the advertisement option selected by the user is displayed and the video is displayed.

### FIELD

This document relates to advertising.

### BACKGROUND

A popular form of advertising is video advertising where a video advertisement (“ad”) is presented prior to or during the playing of video content. A conventional example of such video advertising is found in commercial television broadcasts which include the playing of advertisements during commercial breaks in television programs. Another example of video advertising includes the playing of a video advertisement on a web page using an Internet browser, such as prior to the delivery of free video content.

Viewers are often subjected to advertisements when receiving free content, where the content is paid for or supported by the advertisers. Although advertisers attempt to place advertisements in spots in which users are receptive to the ads (in an attempt to increase probability that the ads will result in revenue generation, name recognition, or the like), viewers conventionally are unable to identify and select what advertisements they will view.

### SUMMARY

According to an aspect, there is disclosed a method. The method includes receiving a user request to view content, providing at least two advertisement options to the user, receiving a user selection of one of the at least two advertisement options, displaying an advertisement associated with the at least one advertisement option selected by the user, and displaying the content.

According to another aspect, the method includes receiving a user request to view a video, providing at least two advertisement options to the user, and receiving a user selection of one of the at least two advertisement options. The method also includes displaying an advertisement associated with the advertisement option selected by the user, and displaying the video.

According to yet another aspect, the method includes receiving a user request to view a video, and displaying at least two advertisement options to the user. If the user does not select at least one of the at least two advertisement options, then displaying at least two advertisements to the user, else displaying an advertisement associated with the at least one user-selected advertisement option. The method also includes displaying the video.

One or more of the following features may also be included. Providing the at least two advertisements options to the user can include displaying at least two thumbnail images. Each of the at least two thumbnail images can include a screen shot of a video advertisement. Addition, displaying the advertisement can include displaying the advertisement prior to displaying the video, or displaying the advertisement subsequent to displaying at least a portion of the video. Displaying the video can alternatively or also include displaying the video prior to providing the at least two advertisement options to the user.

Providing the at least two advertisements options to the user can include displaying at least two thumbnail images. Each of the at least two thumbnail images can include a screen shot of a video advertisement. Additionally, displaying the advertisement can include displaying the advertisement prior to displaying the video, or displaying the advertisement subsequent to displaying at least a portion of the video. Displaying the video can alternatively or also include displaying the video prior to providing the at least two advertisement options to the user.

A user request to view at least one advertisement option can be received. Further, the user request to view at least one advertisement option can occur subsequent to providing at least two advertisement options to the user. An instruction can be provided to the user to select at least one of the at least two advertisements options. Moreover, an option to purchase the video can be provided to the user, for instance, to allow user to avoid watching some or all of an advertisement.

These general and specific aspects may be implemented using a system, a method, or a computer program, or any combination of systems, methods, and computer programs.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows an exemplary advertising system.

FIG. 2 shows a more detailed view of the advertising system of FIG. 1.

FIG. 3a shows an exemplary video player interface.

FIG. 3b shows the video player interface of FIG. 3awith an instruction.

FIG. 4 shows an exemplary video player interface.

FIG. 5 shows another exemplary video player interface.

FIG. 6 shows a block diagram flow chart of an exemplary advertising process.

FIG. 7 shows a block diagram flow chart of an exemplary advertising process including a video purchase option.

FIG. 8 shows a block diagram flow chart of an exemplary advertising process including a user selection to view a user-selected advertisement.

FIG. 9 shows a block diagram flow chart of an exemplary advertising process including a user selection to view a user-selected advertisement.

FIG. 10 shows a block diagram flow chart of an exemplary advertising process including an advertisement interruption of a video.

### DETAILED DESCRIPTION

The present disclosure now will be described more fully hereinafter with reference to the accompanying drawings, in which some, but not implementations are shown. Indeed, these implementations can be embodied in many different forms and should not be construed as limited to the implementations set forth herein; rather, these implementations are provided so that this disclosure will satisfy applicable legal requirements. Like numbers refer to like elements throughout.

The following disclosure describes systems, methods, and computer program products that provide content (e.g., video) and advertisements to users, such as via a user's internet browser Implementations described provide users with the ability to select one or more advertisements a user wishes to view. This selection can occur prior to viewing the content (e.g., a video, such as a free video), or can occur during or after the playing of the content. Although the disclosure focuses on videos and video advertisements, implementations are applicable to selection of advertisements in any media form, including graphics, audio, text, and the like. Additionally, the selection of such advertisements can occur prior to, during, or after a user receives any content, for instance, audio, access to web pages, downloadable programs, or the like.

This disclosure is described with reference to block diagrams and flowchart illustrations of methods, apparatuses (e.g., systems) and computer program products. It will be understood that blocks of the block diagrams flowchart illustrations, and combinations of blocks in the block diagrams and flow chart illustrations, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function(s) specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the function(s) specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

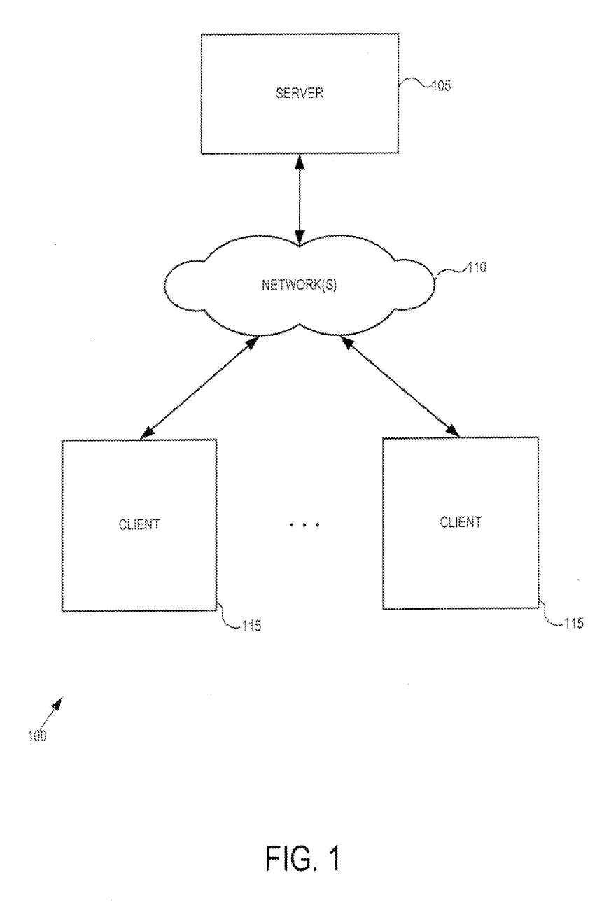

FIG. 1 shows an exemplary advertising system 100, according to an illustrative implementation. The system generally includes at least one server 105 in communication with one or more clients 115 via at least one network 110. The clients 115 can each include a device, such as a personal computer, a wireless telephone, a personal digital assistant (PDA), a lap top computer, or another type of computation, communication or electronic device, a thread or process running on one of these devices, and/or an object executable by one of these devices. The server 120 can include one or more servers that gather, process maintain, manage information and/or provide content (e.g., videos) and advertisements to the clients 115. Although two clients 115 and a single server 105 are illustrated in FIG. 1, there can be more servers and more or fewer clients. For instance, some of the functions performed by the server 105 can be performed by one or more other servers such that the server 105 can represent several devices, such as a network of computer processors and/or servers.

The network(s) 140 can include one or more local area networks (LANs), wide area networks (WANs), telephone networks, such as the Public Switched Telephone Network (PSTN), intranets, the Internet, and/or or other type, of network. The client(s) 115 and server 120 can connect to the network(s) 140 via wired, wireless, or optical or other connections. In alternative implementations, one or more of the devices illustrated in FIG. 1 are directly connected to another one of the devices. For example, in one implementation, the clients 115 are directly connected to the server 120.

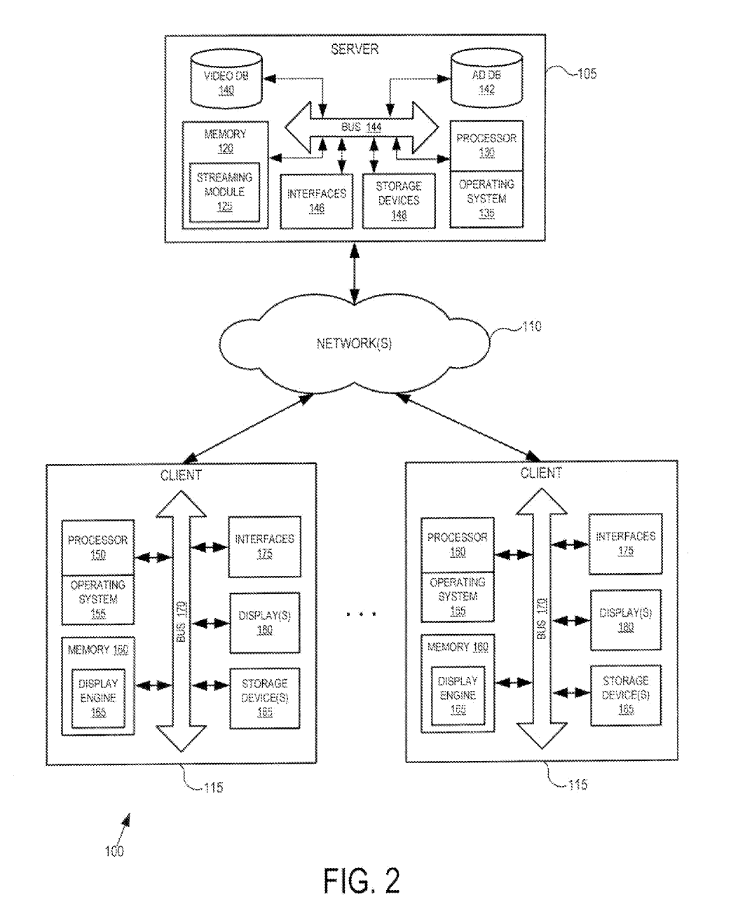

FIG. 2 shows a detailed view of the system 100 shown in FIG. 1. The server 105 generally includes a processor 130, an operating system 135, a memory 120 including a streaming module, a video database 140, an ad database 145, one or more interface(s) 146, one or more storage device(s) 148, and a bus 144. The bus 144 can include one or more paths that permit communication among the components of server 105.

The processor 130 includes any type of conventional processor, microprocessor or processing logic that interprets and executes instructions and works in conjunction with the operating system 135 to execute instructions stored in the memory 120 and/or storage devices 148 of the server 105. The memory 120 can include a random access memory (RAM) or another type of dynamic storage device that stores information and instructions for execution by the processor 130. The storage device(s) 148 can include a conventional ROM device or another type of static storage device that stores static information and instructions for use by the processor 130. Additionally, the storage device(s) 148 can include a magnetic and/or optical recording medium and its corresponding drive. According to an implementation, although the operating system 135 is shown as separate from the memory 120 and storage device(s) 148, the operating system 135 may be stored within the memory 120 and/or storage device(s) 148.

The server 105 includes one or more interfaces 146 that permit input to the server 105 via one or more conventional mechanism, such as a keyboard, a mouse, a pen, voice recognition and/or biometric mechanisms, or the like. The interface(s) 146 can also permit output from the server 105 via one or more conventional mechanisms, such as a display, a printer, a speaker, or the like. The interface(s) 146 can further include one or more communication interfaces that enable tho server 105 to communicate with other permitting the server 105 to communicate with clients 115 via one or more networks, such as the network(s) 110.

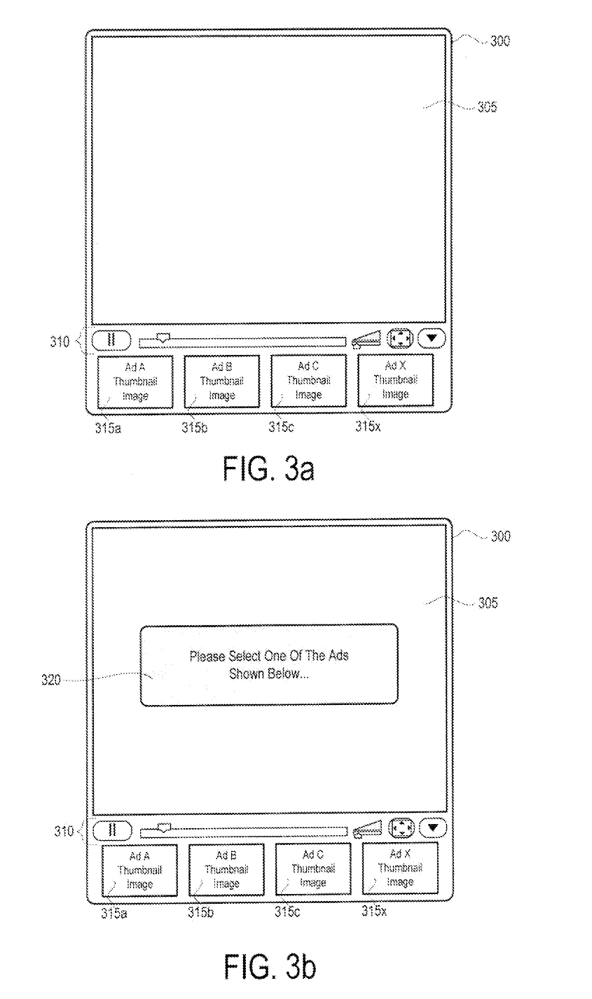

For clarity, reference will be made to a video content system where videos are provided and augmented with advertisements As discussed above, other forms of content are possible. In operation the server 105 can store videos and advertisements in the video database 140 and the ad database 142, respectively. Although separate databases 140, 142 are illustrated in FIG. 2, video and advertisements may be stored within a common database, or in several databases, either internal or external to the server 105. For instance, the server 105 may retrieve advertisements and/or videos from a remote location on the Internet via the interface(s) 146 and the network(s) 110. In response to a client request to view a video, the server is operable to display the video to a user associated with the client. The server is also operable to present one or more user-selectable advertisements for displaying with the video. As described with respect to FIGS. 3a-10 below, the advertisements may be presented before, during, or after a video. A user can select, a particular advertisement for viewing out of two or more alternative advertisements, ad types, ad sources, etc.

In one implementation, the server 105 performs these operations in response to the processor 130 executing software instructions contained in a computer-readable medium, such as the memory 120. In one implementation, the software instructions may be contained in a streaming module 125 within the memory 120. The streaming module 125 is therefore operable to provide video content along with two or more advertisement options that can be selected by a user. As described with reference to FIGS. 3a-10, the streaming module 125 is operable to provide two or more advertisement options for display to a user to allow the user to select at least one of the advertisements alternatives for viewing. The software instructions can be read into the memory 120 from another computer readable medium, such as the storage device(s) 148, or from another device via the interface(s) 146. The software instructions contained in the memory 120 cause processor 130 to perform processes described in this disclosure. Alternatively, hardwired circuitry can be used in place of or in combination with software instructions to implement processes consistent with the disclosure. Thus, implementations are not limited to any specific combination of hardware circuitry and software.

The client device(s) 115 include a processor 150, an operating system 155, a memory 160 including a display engine 165, one or more interface(s) 146, one or more display(s) 180 one or more storage device(s) 185, and a bus 170. The bus 170 includes one or more paths, such as data and address bus lines, to facilitate communication between the processor 150, operating system 155 and the other components within the client 115. The processor 150 executes the operating system 155, and together the processor 150 and operating system 155 are operable to execute functions implemented by the client 115, including software instructions contained in a computer-readable medium stored in the memory 160.

The processor 150 and operating system 155 are operable to execute the display engine 165 stored within the memory 160 to present users with a video and at least one user-selectable advertisement. The display engine 165 enables the display of one or more graphical user interfaces (GUIs) provided by the streaming module 125 through which a user of the client 115 can view videos and select one or more advertisements. Generally, the display engine 165 receives display information received from the server 105, including one or more videos and advertisements, and displays the information to the user via the one or more display(s) 180. The display engine 165 and one or more interface(s), which can include user input/output devices, also permit the user selection of one or more advertisements displayed with at least one video.

The memory 160 in which the display engine 165 resides may comprise random access memory, read-only memory, a hard disk drive, a floppy disk drive, a DVD or CD Rom drive, or optical disk drive, for storing information on various computer-readable media, such as a hard disk, a removable magnetic disk, or a DVD or CD-ROM disk. Additionally, the interface(s) can control input/output devices of the client 115, such as a video display, a keyboard, a scanner, a mouse or joystick or other input or output devices. The interface(s) can also include one or more input/output ports and/or one or more network interfaces that permit the client 115 to receive and transmit information, such as from and to the server 105, such as via the network(s) 110.

The server 105 and clients 115 illustrated in FIG. 2 support combinations of means for performing the specified functions described herein. As noted above, it will also be understood that each block of the block diagrams, and combinations of blocks in the block diagrams, can be implemented by special purpose hardware-based computer systems that perform the specified functions or steps, or combinations of special purpose hardware and computer instructions. Further, the server 105 and clients 115 can each be embodied as a data processing system or a computer program product on a computer-readable storage medium having computer-readable program code means embodied in the storage medium. Any suitable computer-readable storage medium may be utilized including hard disks, CD-ROMs, DVDs, optical storage devices, or magnetic storage devices. Accordingly, the server 105 and/or clients 115 may take the form of an entirely hardware embodiment, an entirely software embodiment or an embodiment combining software and hardware aspects, such as firmware.

Furthermore, though illustrated individually in FIG. 2, each component of the server 105 and clients 115, respectively, may be combined with other components within the server 105 and/or clients 115 to effect the functions described herein. According to an implementation, one or more clients 115 can store videos and advertisements in addition to or as an alternative to the storage of videos and/or advertisements by the server 105 or by another entity in communication with the server 105 via the network(s) 110. Thus, the video database 140 and the ad database 142 may be distributed among one or more clients 115.

FIG. 3a shows an exemplary video player interface 300, according to an illustrative implementation. The video player interface 300 includes a display window 305 in which one or more videos and/or advertisements can be presented to a user. According to a implementation the video player interface 300 is presented to a user by the display engine 165. The display engine 165 and/or streaming module 125 can create interface 300, which is used to display at least one, video and at least one advertisement provided to the client 115 by the server 105. The video player interface 300 also includes one or more control features 310 such as a play/pause button, a player slide bar, volume control, screen size tool, and a minimize and/or close button.

According to one implementation, the video player interface 300 includes at least two advertisement options 315a, 315b, 315c, . . . , 315x each represented by an advertisement thumbnail image. The at least two advertisement options 315a, 315t, 315c, . . . , 315x can appear in the interface 300 prior to the selection of a video by a user for playing or can appear after at least a portion of a video has played. The advertisement thumbnail images are provided from the server 105 to permit user selection of an advertisement to be displayed in the display window 305. By choosing one of the advertisements selections 315a, 315b, 315c, . . . , 315x the user can control the advertisement the user wishes to view prior to receiving a video, such as a free video.

Although described herein with respect to implementations in which actual advertisements correspond to the advertisement options 315a, 315b, 315c, . . . , 315x the advertisement options 315a, 315b, 315c, . . . , 315x can be advertisement sources or types of advertisements. For instance, a user may be presented with advertisement options 315a, 315b, 315c, . . . , 315x that permit the selection of a type of ad, such as ‘sports’ ads or ‘movie’ ads, such that the selection of an advertisement option 315a, 315b, 315c, . . . , 315x will result in additional selections, including actual advertisements. The advertisement options 315a, 315b, 315c, . . . , 315x can also provide links to web sites or other content without providing the user with an advertisement immediately upon selection of an advertisement option 315a, 315b, 315c, . . . , 315x.

According to an implementation shown in FIG. 3b, the video player interface 300 may present the user with an instruction 320 to choose/select one of the advertisement options 315a, 315b, 315c, . . . , 315x prior to displaying a video in the display window 305. This instruction 320 can take the form of a pop-up instruction prior to the playing of a video. The instruction 320 can also be presented during the playing of a video, such as via a pop-up window, and the video may be paused/stopped until the user selects an advertisement option 315a, 315b, 315c, . . . , 315x. Therefore, an advertisement may be inserted into a video which is temporarily paused until the advertisement is completed.

According to an implementation, the advertisement thumbnail images can include screen captures from the advertisements each represents. For instance, each advertisement thumbnail image can be a screen capture from the corresponding video advertisement to suggest to the user what content the associated advertisement might include. The advertisement thumbnail images can alternatively or also include graphics, movie clips (or other moving images), text, or the like. For instance, where an advertisement is a slideshow, the advertisement thumbnail images can include one image from the slideshow. Additionally, according to an implementation, advertisements are not limited to being viewed within the display window 305, and may be presented to a user in a separate window, web page, or the like, after selection of an advertisement option 315a, 315b, 315c, . . . , 315x and prior to the user viewing a video in the display window 305.

The advertisements and their associated advertisement thumbnail images are provided by the streaming module 125 of the server 105. Each may be stored within one or more databases internal to the server, such as the ad database 142 and/or video database 140, or may be retrieved from one or more databases external to the server 105. According to an implementation, the advertisement thumbnail images are selected by the server 105, transmitted to the client 115, and displayed to the user via the display engine and the display(s) 180. The full content of each advertisement represented by the advertisement thumbnail images, such, as video advertisement, can also be transmitted to the client 115 for display upon user selection of one of the advertisement thumbnails. According to another implementation, the full content of each advertisement is retrieved by the client 115 via the network(s) 100 only after a user chooses an advertisement option 315a, 315b, 315c, . . . , 315x.

According to an implementation, the advertisements available to the user and/or the resulting user-selected advertisement may be stored by the client 115 and transmitted to the server 105. The server 105 can maintain a log of this information in the storage device(s) 148, or in another table internal or external to the server 105. The server 105 can utilize this information to generate reports that indicate those advertisements selected by users. Additionally, the server 105 can utilize this information to determine those advertisements that should be provided as advertisement options 315a, 315b, 315c, . . . , 315x to users. For instance, if a particular advertiser is playing for 100 views of a particular advertisement, the server 105 may present the advertisement as an advertisement option 315a, 315b, 315c, . . . , 315x until users select to view the advertisement for a total of 100 times. Advertisers can also receive feedback to determine those ads which are more popular among users, such that they request placement by the server of ads that are more often viewed.

According to another implementation, the server 105 can track each user's advertisement selections and use that information to determine those advertisements that should be provided as advertisement options 315a, 315b, 315c, . . . , 315x to the user. Therefore, a user advertisement profile call be stored by the server 105 information in the storage device(s) 148, or in another table internal or external to the server 105. Each advertisement maybe associated with metadata identifying the type advertisement. If a user typically selects ads of a certain type, as identified by the metadata associated with the selection, the server 105 will identify this data in the user's advertisement profile and may alter the advertisement options 315a, 315b, 315c, . . . , 315x to provide the user with ads the user likely to view. Although metadata can be used to effect this processing, other techniques of associating an advertisement with a type can be employed.

In yet another implementation, a user may be provided one or more advertisement options. If the user does not select at least one of the advertisement options, such as from two alternatives, then the user may be required to view a series of advertisements, such as two advertisements back to back. This may serve to encourage user selection, of an advertisement option.

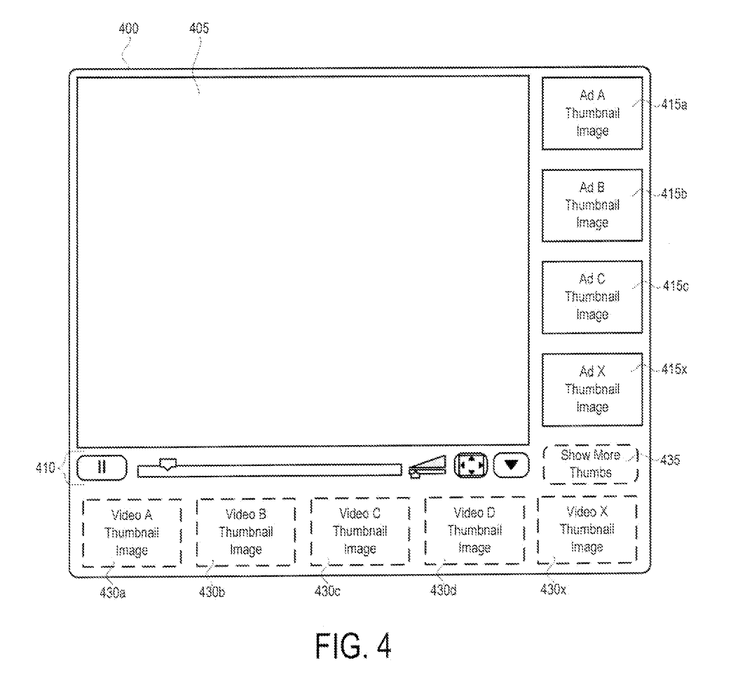

Next, FIG. 4 shows a video player interface 400, according to an illustrative implementation. The video player interface 400 is similar to the interface 300 described above with respect to FIG. 3, and includes a display window 405 in which one or more videos and/or advertisements can be presented to a user. The video player interface 400 also includes one or more control features 410, such as a play/pause button, a player slide bar, volume control, screen size tool, and a minimize and/or close button. Like the interface 300 of FIG. 3, the video player interface 400 of FIG. 4 is presented to a user by the display engine 165. The display engine 165 and/or streaming module 125 can create the interface 400, which is used to display at least one video and at least one advertisement provided to the client 115 by the server 105.

The video player interface 400 includes several advertisement options 415a, 415b, 315c, . . . , 415x each represented by a thumbnail image provided from the server 105 to permit a user to select an advertisement the user wishes to view. The video player interface 400 also includes one or more video selections 430a, 430b, 430c, 430d, . . . , 430x, which can also include thumbnail images, such as screen captures, of videos available to the user for viewing in the display window 405.

The operation of the video player interface 400 shown in FIG. 4 is similar to that of the video player interface 300 shown in FIG. 3. However, the video player interface 400 also includes a ‘show more thumbs’ button 435. The ‘show more thumbs’ button 435 permits the user to view, new advertisement options each represented by a corresponding advertisement thumbnail image. For instance, by selecting the ‘show more thumbs’ button 435 each of the advertisement options 415a, 415b, 415c, . . . , 415x represented by associated thumbnail images may be updated. Thus, the advertisement options 415a, 415b, 415c, . . . , 415x may represent a queue, where a viewed advertisement, a partially viewed advertisement, or an unwanted advertisement option is dropped as an advertisement option 415a, 415b, 415c, . . . , 415x and updated by the server 105 with an alternative selection 105. This permits a user to view continuous new advertisement options for selection. According to another implementation, the ‘show more thumbs’ button 435 may update one or all of the advertisement options 415a, 415b, 415c, . . . , 415x displayed on the interface 400.

According to another implementation, the interface 400 can include a ‘show next ad’ button (not illustrated) that permits a user to interrupt the viewing of a playing advertisement. If this occurs a new advertisement is automatically presented to the user. The replacement advertisement may include one of the advertisements represented by the advertisement thumbnail images, or may be a different advertisement selected by the server 105. This feature is advantageous when a user must view an entire advertisement prior to viewing a video because a user can continuously view advertisement options until the user views an advertisement the user wishes to view in its entirety. Additionally, although not illustrated in a separate interface, the video player interface 400 may present the user with an instruction to choose/select one of the advertisement options 415a, 415b, 415c, . . . , 415x, prior to displaying a video in the display window 405, as described with respect to FIG. 3b.

As described with respect to FIG.3a, the advertisements and their associated advertisement thumbnail images are provided by the streaming module 125 of the server 105. The advertisement thumbnail images can be selected by the server 105, transmitted to the client 115, and displayed to the user via the display engine and the display(s) 180. The full content of each advertisement represented by the advertisement thumbnail images, such as video advertisements, can also be transmitted to the client 115 for display upon user selection of one of the advertisement thumbnails, or the full content of each advertisement is retrieved by the client 115 via the network(s) 100 only after a user chooses an advertisement option 315a, 315b, 315c, . . . , 315x.

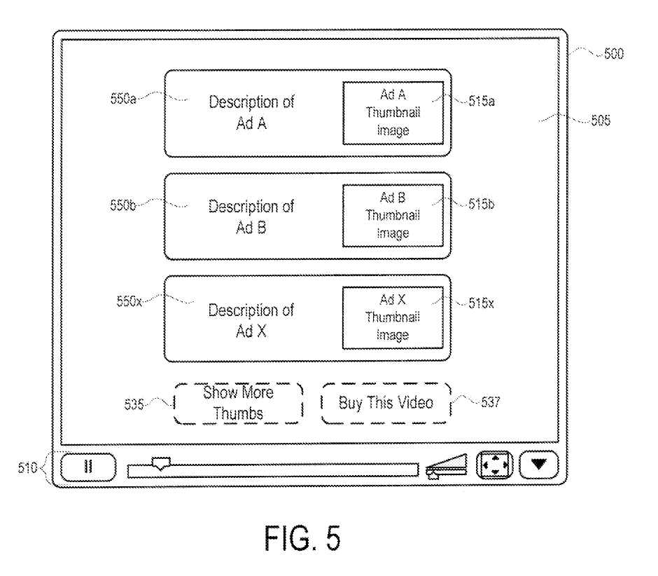

FIG. 5 shows an exemplary video player interface 500, according to another illustrative implementation. The video player interface 500 includes a display window 505 in which one or more videos and/or advertisements can be presented to a user. The video player interface 500 also includes one or more control features 510, such as a play/pause button, a player slide bar, volume control, screen size tool, and a minimize and/or close button. Like the interfaces 300, 400 described above, the video player interface 500 of FIG. 5 is presented to a user by the display engine 165 and may be created by the display engine 165 and/or streaming module 125 to display at least one video and at least one advertisement to the client 115.

The video player interface 500 of FIG. 5 includes advertisement options 515a, 515b, . . . , 515x represented by associated thumbnail images. Unlike the illustrative implementations described with respect to FIGS. 3a-4, the advertisement options 515a, 151b, . . . , 515x and their associated thumbnail images appear in the display window 505. These may alternatively appear in a pop-up window on the user's display or outside the area of he display window as shown in FIGS. 3a and 4 . As shown in FIG. 5, in addition to the thumbnail images, each of the advertisement options 515a, 515b, . . . , 515x can be presented with a corresponding advertisement description 550a, 550b, . . . , 550x that may present additional information to the user to assist the user in selecting the correct advertisement he user wishes to view. This information can include the length of the advertisement, product or service information, or any other information the advertisement an administrator of the server 115) may want the user to view. This information can be provided to the client 115 by the server 105 in the same manner in which the advertisement thumbnail images are provided. According to an implementation, the advertisement descriptions 550a, 550b, . . . , 550x can be generated from a source other than the server 105, such as being provided directly by an advertiser that can choose to update the information at the advertiser's discretion.

FIG. 5 also shows a ‘show more thumbs’ button 535, which operates the same as the ‘show more thumbs’ button 435 of FIG. 4, such that it causes new ads to replace one or more of the advertisement options 515a, 515b, . . . , 515x. A ‘buy this video’ button 537 is also shown in the video player interface 500. This button 537 permits a user to select to purchase a video without viewing one or more advertisement options. By choosing to purchase a video, the user can be presented with a payment interface to pay for the video, which allows the user to pay for the video in order to avoid having to watch an advertisement prior to viewing the video. Although the ‘buy this video’ button 537 is shown in the display window 505 the button (or selection) may alternatively appear in another area of the interface 500, such as outside the area of the display window 505, in a pop-up window, or the like.

Any and/or all of the features described in FIGS. 3a-5 may be implemented in a single interface. Additionally, according to an implementation, the order in which advertisement options are presented to users may be determined by the server 105 can also be based on revenue provided by advertisers. For instance, an advertiser paying more money for placement of an advertisement may request that the advertisers' ads always appear as the first possible selection in a video player interface. An advertiser may also demand that the advertisement be placed as a possible advertisement option in a larger number of video player interfaces across all users. According to yet another implementation, a particular selection may be highlighted in an attempt to persuade the user to select that particular advertisement from two or more options.

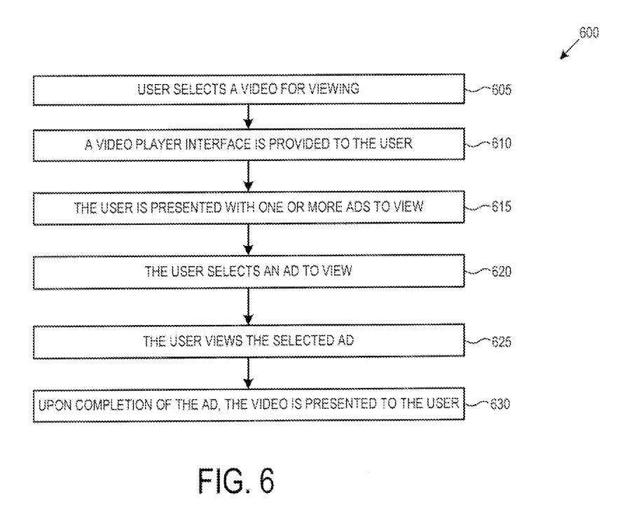

FIG. 6 shows a block diagram flow chart of an exemplary advertising process, according to an illustrative implementation. The process begins with the user's selection of a video for viewing (block 605). This may occur, for instance, by the user's selection of a link on a web page. Alternatively, the selection of a video may be provided from a video player interface, such as the interface 400 of FIG. 4. If the user video player interface isn't already provided, it is generated by the display engine 165 and/or streaming module 125 (block 610). The user is then presented with one or more advertisements to view (block 615). This can include the presentation of several advertisement options each from the server 105 to permit user selection of an advertisement the user wishes to view prior to viewing the video.

Next, after the user selects an ad to view the selected ad is displayed to the user (blocks 620, 625). The user can select an ad, for instance, by clicking on one of the advertisement can be transmitted to the client 115 from the server 105 upon user selection of the advertisement, or can be pre-loaded upon generation of the video player interface. After the ad is viewed, the user-selected video (block 605) is presented to the user (block 630) e.g., from the server 105.

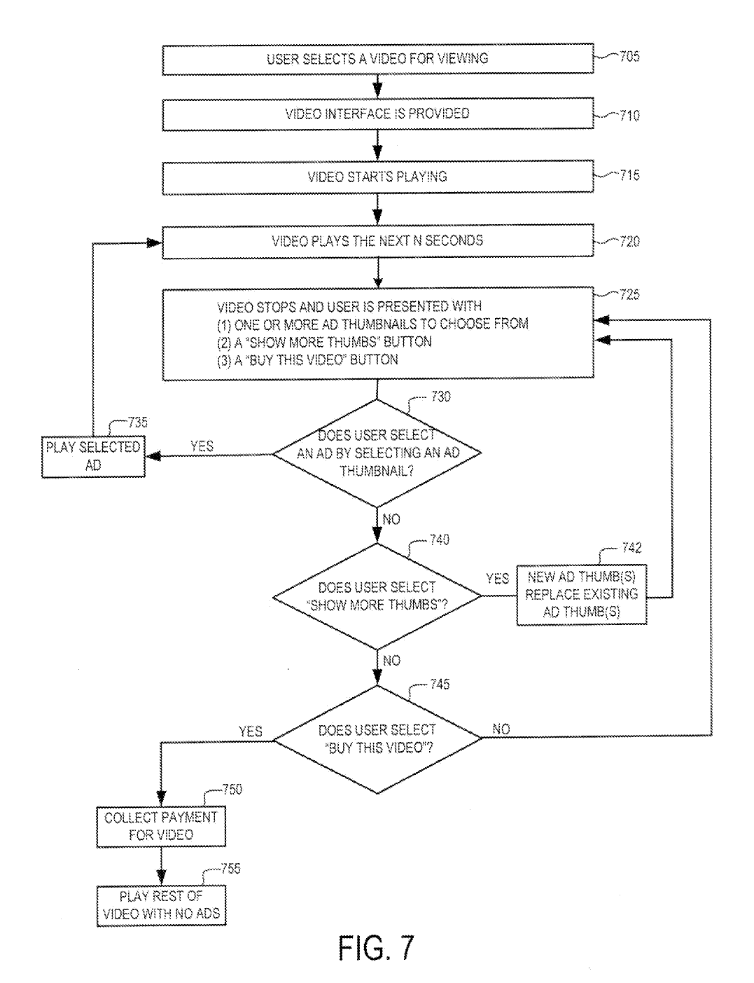

FIG. 7 shows a block diagram flow chart of an advertising process including a video purchase option, according to an illustrative implementation. A user selects a video for viewing (block 705), and a video interface is provided (block 710). According to an implementation, the video starts to play (block 715) using the video interface. The video plays for a period of time, such as ‘N’ seconds (block 720), and then stops. The instruction to stop the video may be received by the client 115 from the server 105, either at the time the video is playing or before the video starts to play. The user is then presented with one or more advertisement thumbnails to choose from, and/or a ‘show more thumbs’ button, and/or a ‘buy this video’ button, the functions of which are described above with reference to the video interfaces of FIGS. 3a-5 (block 725).

If the user selects to view an advertisement by selecting an advertisement thumbnail image (block 730), the selected advertisement is displayed to the user. According to an implementation, this can occur via the display(s) 180 of the client 115. The video can then play until it ends, or can play for another period of time before the video is interrupted and the process of presenting the user with more advertisements, or the ability to purchase the video, is repeated (blocks 720, 725). If the user does not select an advertisement thumbnail image (block 730), but instead selects ‘show more thumbs’, one or more of the advertisement thumbnail images are replaced with new advertisement thumbnail images to identify that new advertisement options are available (block 742). The user is again presented with one or more advertisement thumbnails to choose from, and/or a ‘show more thumbs’ button, and/or a ‘buy this video’ button (block 725). According to an implementation, the server 105 transmits the new advertisement thumbnail images to the client 115 upon selection of the ‘show more thumbs’ button.

If the user does not select an advertisement thumbnail image (block 730) or request to view more thumbnail images (block 740), but instead selects to ‘buy this video’ (block 745) payment may be collected for the video (block 750). In one implementation, one or more interfaces may be provided by the server 105 or an external source (e.g., web site) to permit collection of payment. After payment is received, the remainder of the video is played without interruption by advertisements (block 755).

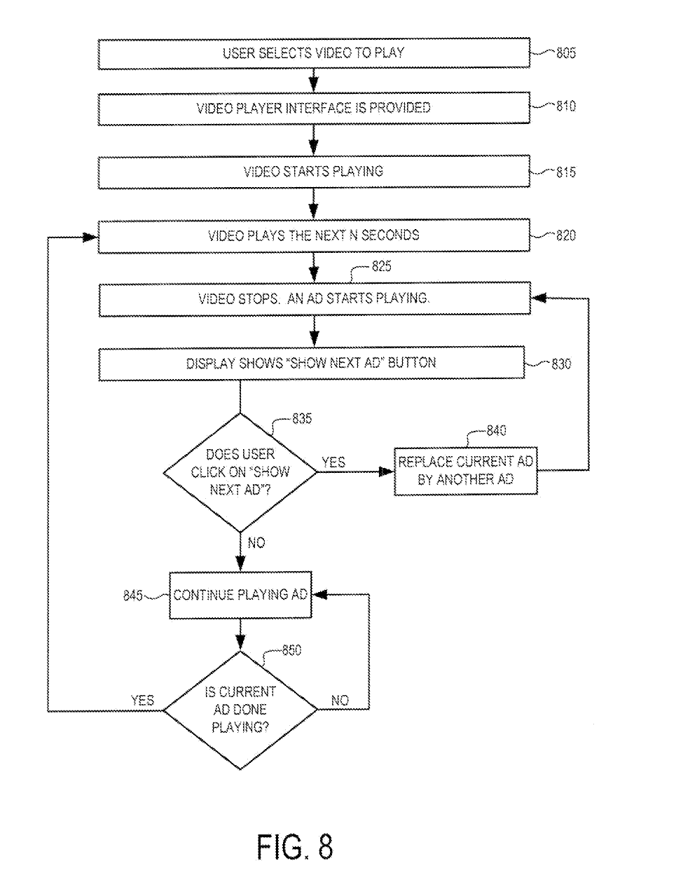

FIG. 8 shows a block diagram flow chart of a exemplary advertising process including a user selection to view a user-selected advertisement. A user selects a video for viewing (block 805), and a video interface is provided to the user (e.g., via the client 115) (block 810). According to an implementation, the video starts to play (block 815) using the video interface. The video plays for a period of time, such as ‘N’ seconds (block 820), and then stops so that an advertisement begins to play (block 825).

The user is presented with a ‘show next ad’ button (block 830), which the user can select to skip the currently playing advertisement (block 835). For example, if the user chooses to skip the advertisement, the server 105 instructs the client 115 to display a new advertisement to the user (block 840). According to an implementation, each new advertisement presented to the user starts at the beginning of the advertisement. If the user elects not to skip the advertisement (block 835), the advertisement continues playing until it is done playing (blocks 845, 850). After the advertisement his completed playing the video continues to play, which can occur until its completion or until it is interrupted by another advertisement, which may be dictated by the server 105.

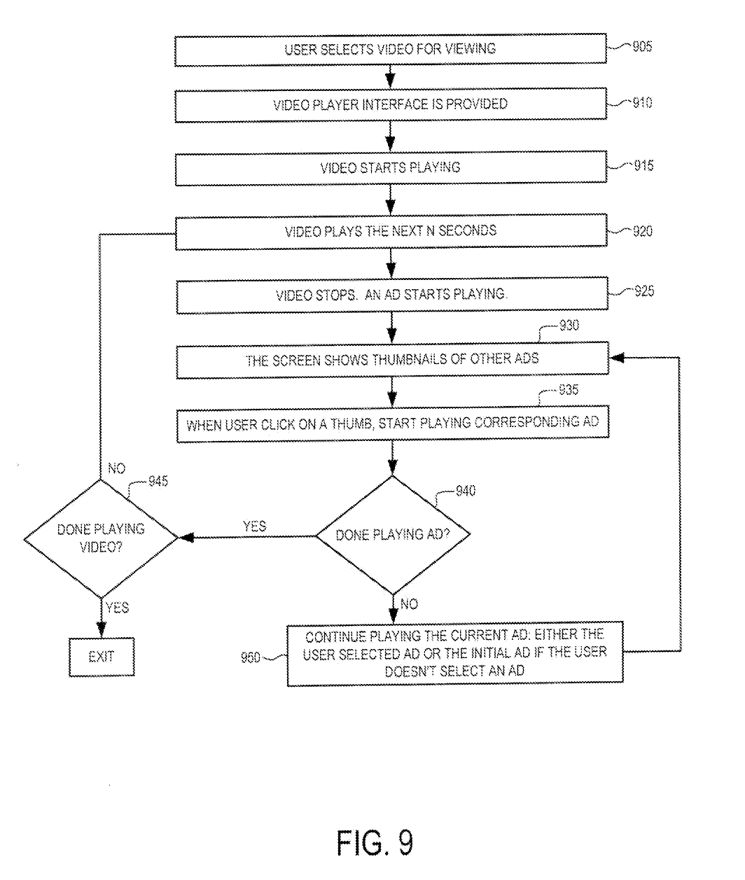

FIG. 9 shows a block diagram flow chart of an exemplary advertising process including a user selection to view a user-selected advertisement. A user selects a video for viewing (block 905), and a video interface is provided to the user (e.g., via the client 115) (block 910). According to an implementation, the video starts to play (block 915) (e.g., using the video interface). The video plays for a period of time, such as ‘N’ seconds (block 920), and then stops at which time an non user selected advertisement (e.g., selected by the server 105) begins to play (block 925). As with the previous implementations, the period of ‘N’ seconds may be zero seconds such that the ad plays before the video begins to play. Alternatively, the advertisement may interrupt the video after the video plays for a period of ‘N’ seconds.

The user is presented with advertisement options (e.g, thumbnail images) representing alternative advertisements available for viewing by the user (block 930). Upon selection of an advertisement option (e.g., thumbnail image), the advertisement corresponding to the selected advertisement option begins to play (block 935). The user-selected advertisement can be provided to the video interface by the server 105. If the user-selected advertisement has completed playing (block 940), the video continues to play if there is time remaining on the video (block 945). If the advertisement has not completed playing (block 940), the ad continues playing while the alternative ads available to the user (e.g., as represented by the advertisement thumbnail images) continue to be shown to the user possible user selection (block 950).

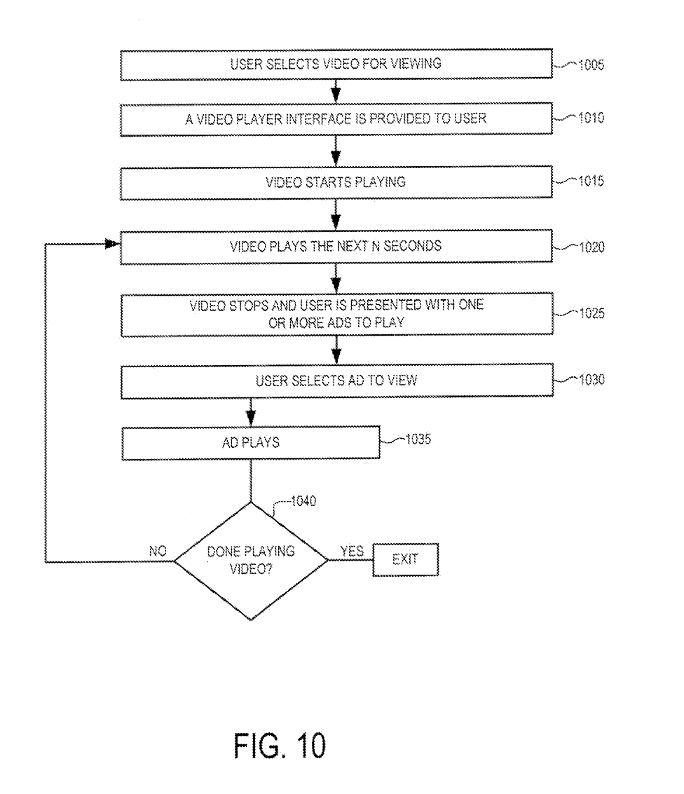

FIG. 10 shows a block diagram flow chart of an exemplary advertising process including an advertisement interruption of a video. A user selects a video for viewing (block 1005), and a video interface is provided to the user (e.g., via the client 115) (block 1010). According to an implementation, the video starts to play (block 1015) using the video interface. The video plays for a period of time, such as ‘N’ seconds (block 1020), and then stops at which time the user is presented with one or more advertisement options (e.g., thumbnail images) representing alternative advertisements available for viewing by the user (block 1025). Upon selection of an advertisement option, the advertisement corresponding to the selected advertisement option begins to play (blocks 1030, 1035). In an implementation, the user-selected advertisement can be provided to the video interface by the server 105. Once the user-selected advertisement has completed playing, the video continues to play it there is time remaining on the video (block 1040).

The apparatus, methods, flow diagrams, and structure block diagrams described in this patent document may be implemented in computer processing systems including program code comprising program instructions that are executable by the computer processing system. Other implementations may also be used. Additionally, the flow diagrams and structure block diagrams described in this patent document, which describe particular methods and/or structural means, may also be utilized to implement corresponding software structures and algorithms, and equivalents thereof.

Many modifications and other implementations will come to mind to one skilled in the art having the benefit of the teachings presented in the foregoing descriptions and the associated drawings. Therefore, it is to be understood that the disclosure is not limited to the specific implementations disclosed and that modifications and other implementations are intended to be included within the scope of the appended claims. Although specific terms are employed herein, they are used in a generic and descriptive sense only and not for purposes of limitation.

That which is claimed:

1. A method, comprising:
receiving a user request to view a video;
providing at least two advertisement options to the user;
receiving a user selection of one of the at least two advertisement options;
displaying an advertisement associated with the at least one advertisement option selected by the user; and
displaying the video.

2. The method of claim 1, wherein providing the at least two advertisements options to the user comprises displaying at least two thumbnail images.

3. The method of claim 2, wherein each of the at least two thumbnail images comprises a screen shot of a video advertisement text, or animated images.

4. The method of claim 1, wherein displaying the advertisement comprises displaying the advertisement prior to displaying the video.

5. The method of claim 1, wherein displaying the advertisement comprises displaying the advertisement subsequent to displaying at least a portion of the video.

6. The method of claim 1, wherein displaying the video comprises displaying the video prior to providing the at least two advertisement options to the user.

7. The method of claim 1, further comprising receiving a user request to view at least one advertisement option.

8. The method of claim 1, wherein the user request to view at least one advertisement option occurs subsequent to providing at least two advertisement options to the user.

9. The method of claim 1, further comprising providing an instruction, to the user to select at least one of the at least two advertisements options.

10. The method of claim 1, further comprising providing an option to the user to purchase the video.

11. A system, comprising:
means for receiving a user request to view video;
means for providing at least two advertisement options to the user;
means for receiving a user selection of one of the at least two advertisement options;
means for displaying an advertisement associated with the advertisement option selected by the user; and
means for displaying the video.

12. The system of claim 11, wherein the means for providing the at least two advertisement options to the user Comprises means for displaying at least two thumbnail images.

13. The system of claim 12, wherein each of the at least two thumbnail images comprises a screen shot of a video advertisement text, or animated images.

14. The system of claim 11, wherein the means for displaying the advertisement comprises means for displaying the advertisement prior to displaying the video.

15. The system of claim 11, wherein the means for displaying the advertisement comprises means for displaying the advertisement subsequent to displaying at least a portion of the video.

16. The system of claim 11, wherein the means for displaying the video comprises means for displaying the video prior to providing the at least two advertisement options to the user.

17. The system of claim 11, further comprising means for receiving a user request to view at least one advertisement option.

18. The system of claim 11, wherein the user request to view at least one advertisement option occurs subsequent to providing at least two advertisement options to the user.

19. The system of claim 11, further comprises means for providing an instruction to the user to select at least one of the at least two advertisements options.

20. The system of claim 11, further comprising means for providing a option to the user to purchase the video.

21. A method, comprising:
receiving a user request to view a video;
displaying at least two advertisement options to the user;
if the user does not select at least one of the at least two advertisement options, then displaying at least two advertisements to the user, else displaying an advertisement associated with the at least one user-selected advertisement option; and
displaying the video.

22. The method of claim 21, wherein displaying the at least two advertisements options to the user comprises displaying at least two thumbnail images.

23. The method of claim 22, wherein each of the at least two thumbnail images comprise a screen shot of a video advertisement, text, or animated images.

24. The method of claim 21, wherein displaying an advertisement associated with at least one user-selected advertisement option comprises displaying the advertisement associated with at least one user-selected advertisement option prior to displaying the video.

25. The method of claim 21, wherein displaying the advertisement associated with at least one user-selected advertisement option comprises displaying the advertisement associated with at least one user-selected advertisement option subsequent to displaying at least a portion of the video.

26. The method of claim 21, wherein displaying the video comprises displaying the video prior to displaying at least two advertisement options to the user.

27. The method of claim 21, further comprising receiving a user request to view at least one advertisement option.

28. The method of claim 21, wherein the user request to view at least one advertisement option occurs subsequent to displaying at least two advertisement options to the user.

29. The method of claim 21, further comprising providing an instruction to the user to select at least one of the at least two advertisement options.

30. The method of claim 21, further comprising providing an option to the user to purchase the video.

31. A method, comprising:
receiving a user request to view content;
providing at least two advertisement options to the user;
receiving a user selection of one of the at least two advertisement options;
displaying an advertisement associated with the at least one advertisement option selected by the user; and
displaying the content.

32. The method of claim 31, wherein providing at least two advertisements options to the user comprises displaying at least two thumbnail images.

33. The method of claim 32, wherein each of the at least two thumbnail images comprises a screen shot of a video advertisement, text, or animated images.

34. The method of claim 31, wherein displaying the advertisement comprises displaying the advertisement prior to displaying the content.

35. The method of claim 31, wherein displaying the advertisement comprises displaying the advertisement subsequent to displaying at least a portion of the content.

36. The method of claim 31, wherein displaying the content comprises displaying the content prior to providing the at least two advertisement options to the user.

37. The method of claim 31, further comprising receiving a user to view at least one advertisement option.

38. The method of claim 31, wherein the content is a web page or a video.
